(19) United States
(12) Patent Application Publication
(10) Pub. No.: US 2011/0204183 A1
(43) Pub. Date: Aug. 25, 2011

(54) PORTABLE TABLE

(75) Inventors: Tien Shyang Timothy Chua, Singapore (SG); Shin Yue Leong, Singapore (SG)

(73) Assignee: Singapore Airlines Limited, Singapore (SG)

(21) Appl. No.: 13/060,227

(22) PCT Filed: Aug. 22, 2008
(86) PCT No.: PCT/SG2008/000309

§ 371 Date: May 9, 2011

(51) Int. Cl. B64D 11/00; A47B 3/00; A47B 37/00

(52) U.S. Cl. 244/118.6; 108/152; 108/134; 108/50.11

(57) ABSTRACT

A portable table for reclining seats, non-reclining seats or even permanent bed structures of an aircraft is disclosed. The portable table includes a table-top and a stand assembly, wherein the table-top is pivotally connected to the stand assembly such that the table-top can move from an erect orientation in which the table-top is supported laterally to the stand assembly and a collapsed orientation in which the table-top is substantially parallel to the stand assembly. The stand assembly also includes a re-leasable connector in the form of a clamping device for releasably mounting the portable table to a railing or other suitable support structure on the side of a seat or a bed of an aircraft.

### FIELD OF THE PRESENT INVENTION

The present invention relates to a portable table and in particular to a portable table suitable for aircraft.

### BACKGROUND OF THE PRESENT INVENTION

Tables for aircraft are generally in the form of a folding table. In the case of an economy section of an aircraft, the tables usually fold down from a back of a seat and are used by a person sitting in a seat behind. Tables in business or first class sections of an aircraft usually fold away in the arm rest of the seat.

With the advent of larger passenger aircraft some flight services also offer passengers an option of a reclining seating that can transform into a bed or even a permanent bed separate from a seat.

It is an aim of the present invention to provide a portable table that may, for example, be capable of being used on or interchanged between reclining seats, non-reclining seats or even a permanent bed.

### SUMMARY OF THE PRESENT INVENTION

According to the present invention there is provided a portable table suitable for an aircraft, the portable table including:
a) a table-top; and
b) a stand assembly, wherein the table-top is moveably connected to the stand assembly such that the table-top can be changed from an erected orientation in which the table-top is supported laterally to the stand assembly and a collapsed orientation in which the table-top is substantially parallel to the stand assembly, and wherein the stand assembly includes a releasable connector for releasably mounting the portable table to an object that can act as a support for the table.

The object may be any object to which the table can be attached and that can act as a support for the table, including but not limited to a hospital bed or a wheel chair.

However, the object of particular interest to the applicant is aircraft fittings and furniture such as aircraft beds, reclining seats or non-reclining seats.

One end of the stand assembly may be pivotally connected to the table top to allow the table-top to pivot between the erected orientation and the collapsed orientation.

The pivot connection may allow the table-top to be separated from the stand assembly.

However, the pivot connection may also be a hinge mechanism that retains the table-top and the stand assembly interconnected during movement of the table-top between the collapsed and the erected orientations.

The hinge mechanism may be pivotally connected to an underside of the table-top.

Although the table-top may have any shape, suitably the table top is a square or rectangular shape.

The table may include a stop member that, when in an operative position, bears against and prevents the table-top from moving into the collapsed orientation when the table-top is erected, and when in an inoperative position allows the table-top to move into the collapsed orientation.

The stop member may be in the form of a retractable arm that can be moved between the operative position in which the arm bears against the underside of the table-top and the inoperative position in which the table-top can be moved into the collapsed position. Suitably, the arm is pivotally mounted to the stand assembly and can be pivoted between the operative position and the inoperative position.

The table may include a locking mechanism that can lock the stop member arm in the operative position and thereby prevent the table-top from inadvertently collapsing while in use. In other words, if a passenger moving about the cabin inadvertently knocks the table-top, the stop member will secure the table-top in position preventing the table-top from collapsing.

The locking mechanism may be any suitable mechanism that can secure the stop member in the operative position and may, for example, be in the form of pins, bolts, co-operating magnetised portions or co-operating inter-fitting male and female formations on the table-top and the stop member.

The locking mechanism may include a flange protruding from the underside of the table-top and the stop member may be coupled to the flange by the locking mechanism to secure the stop member in the operative position and to prevent the table-top from pivoting into the collapsed position.

The table may include a swivel mechanism that allows the table-top to pivot or rotate about an axis substantially lateral to a plane of the table-top when in the erected orientation.

The swivel mechanism may be built into the table-top itself, or alternatively, may form part of the stand assembly including the releasable connector for mounting the table to the object.

The stand assembly may include two sections which, when the table is viewed in the erected orientation, are upper and lower sections, and the sections are interconnected by the swivel mechanism.

The swivel mechanism may be of any form but is suitably in the form of co-operating male and female formations that allow free rotation relative to each other.

The female formation may be in the form a cavity having a large diameter and a shoulder that defines a narrow opening to the cavity. The male formation may have a head located in the cavity and a neck located in the narrow opening and extending between the upper and lower formations. The female and the male formations may form part of either one of the upper and lower sections of the stand assembly.

The upper and lower sections of the stand assembly may have a narrow waist section at the swivel mechanism.

The upper section may have shoulders that can abut against and extend in a direction across the width of the table-top when erected.

The releaseable connector is suitably capable of releasably engaging, coupling or locking the stand assembly to the object. For example, the stand assembly may be locked to the object by means of pins, bolts or other members that are received by openings. The openings that receive the pins, bolt or other members may form part of the object or alternatively, may form part of the stand assembly.

However, preferably the releaseable connector is in the form of a clamping device having a fixed engagement surface and an adjustable engagement surface that can each bear against the object and frictionally secure the stand assembly to the object.

Suitably, the fixed engagement surface and the adjustable engagement surface are oppositely disposed and can engage opposite sides of the object, and the adjustable engagement surface is mounted to the stand assembly by way of a screw threaded rod that enables the spacing between the adjustment engagement surface and the fixed engagement surface to be adjusted. In other words, the portable table can be mounted to the object by manoeuvring the adjustable engagement surface into engagement with the object and removing the table from the object by releasing the adjustable engagement surface.

In use, it is preferred that the table be mounted to the object with the fixed and the adjustable engagement surfaces extending longitudinally on the object.

The releasable connector may be in the form of an invert U-shape that can straddle the object to which the portable table is mounted and the adjustable engagement surface may be screw threadably mounted to one of the legs of the U-shape and the fixed engagement may be provided by the other leg of the U-shape.

The inverted U-shape may be located at the foot of the lower section.

According to the present invention there is also provided a combination including:
a) an aircraft lounge in the form of either a seat or a bed of an aircraft; and
b) a portable table including i) a table-top, and ii) a stand assembly, wherein the table-top is moveably connected to the stand assembly such that the table-top can be changed from an erected orientation in which the table-top is supported laterally of the stand assembly and a collapsed orientation in which the table-top is parallel to the stand assembly, and wherein the stand assembly includes a releasable connector for releasably mounting the portable table to the aircraft seat or bed.

The combination of the aircraft lounge and the portable table of the present invention may also include any one or a combination of the features of the portable table described in paragraphs above.

Preferably the aircraft lounge comprises a reclining seating that can transform into a bed or a bed that is separate from a seat.

### BREIF DESCRIPTION OF THE DRAWINGS

An embodiment of the present invention is now described in detail with reference to the accompanying figures, of which:

FIG. 1 is an exploded right perspective view of a portable table according to an embodiment of the present invention, the portable table comprising a stand assembly and a table-top of which a section has been omitted to enable underneath the table-top to be viewed;

FIG. 2 is a left perspective view of the portable table shown in FIG. 1 located in an erected, in use orientation, wherein the stand assembly is shown in solid lines and the table-top is shown in broken lines;

FIG. 3 is a side view of the portable table shown in FIG. 2;

FIG. 4 is an enlarged cross-sectional view of a section of the stand assembly identified by the circle in FIG. 3; and

FIG. 5 is a side view of the portable table shown in FIG. 2 with the table in a collapsed orientation.

### DETAILED DESCRIPTION

The present invention will now be described with reference to a portable table that can be releasably mounted to aircraft seats including conventional upright seats that recline to a small extent, seats that can recline into a substantially horizontal bed, and dedicated beds. However, it will be appreciated that the portable table of the present invention can be used in a variety of applications and can be mounted to seats or beds of various vehicles including ships, buses and trains or in applications other than vehicles such as hospital beds and wheel chairs.

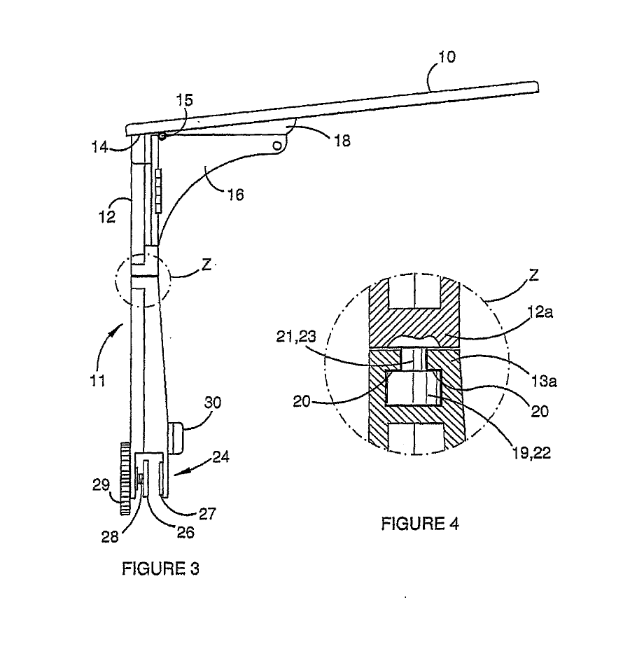

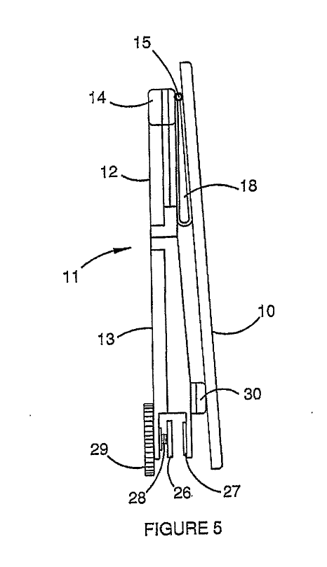

With references to the figures, the portable table comprises a table-top 10, and a stand assembly 11 to which the table-top 10 is pivotally connected. The table-top 10 is pivotal about an axis at the top of the stand assembly that allows the table-top to move from an erect orientation, as shown in side view in FIG. 3, to a collapsed orientation as shown in FIG. 5.

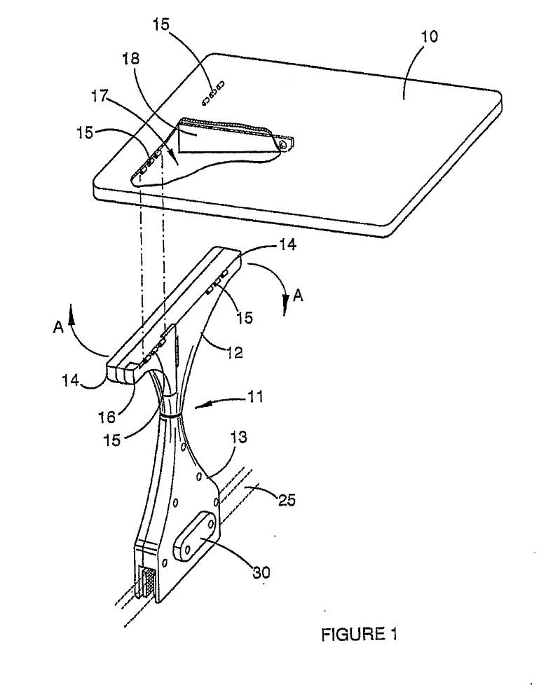

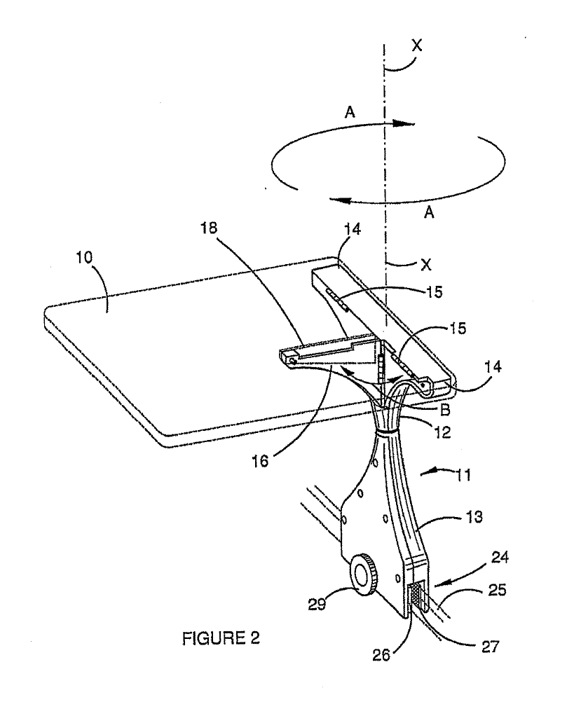

The stand assembly 11 is specifically adapted to enable the portable table to be releasably mounted to objects 25 such as railings on the side of aircraft seating or beds thereby enabling cabin crew to mount the portable to a passenger's chair or bed depending upon the passenger's requirements. When the portable table is not required, the cabin crew can dismount the portable table from the chair or bed, fold the portable table into a collapsed orientation as shown in FIG. 5 and stow the collapsed table as desired. The storage feature is an important feature for aircraft that have substantial space constraints. In addition, the portable table includes locking features to prevent the table from inadvertently folding into a collapsed orientation whilst in use and a swivel mechanism to enable passengers to swivel the table-top 10 back and forth in the direction of arrows A in FIGS. 1 and 2 to facilitate passengers leaving their seats or beds without folding the table-top 10 or removing the portable table from their chair or bed. The locking features are important from the viewpoint of passenger safety. The swivel feature is important from the viewpoint of passenger comfort and convenience. This is particularly the case for passengers occupying seats that can be transformed into beds and beds that are separate from seats who otherwise may have to wait for cabin crew to remove tables to allow the passengers to get up from the beds and move around an aircraft cabin.

As can be seen in FIG. 1, the table-top 10 is essentially a rectangular member made of any suitable material including moulded plastics material. Preferably the material is a lightweight material given the substantial weight constraints of aircraft. One such suitable material is a honeycomb material that is both lightweight and strong.

The stand assembly 11, when viewed in an upright position as shown in FIGS. 1 to 3, comprises upper and lower sections 12 and 13 respectively. The upper section 12 is a body comprising shoulders 14 each having upwardly facing flat abutment surfaces which extend in a direction across the width of the table-top 10. The upwardly facing abutment surfaces of the shoulders 14 and the underside of the table-top 10 comprise a hinge mechanism 15 that allows the table-top 10 to pivot from the erected orientation to the collapsed orientation shown in FIG. 5. The exploded view of the table-top 10 and the stand assembly 11 shown in FIG. 1 illustrates the alignment of the hinge mechanism 15 on the shoulders 14 and the bottom side of the table-top 10.

In addition, a stop member, in the form of an arm 16 for securing the table-top 10 in the erected orientation is pivotally mounted to the upper section of the stand assembly 12. The arm 16 is pivotable in the directions of arrows B between an operative position as shown in FIG. 2 and an inoperative position as shown in

FIG. 1. When located in an inoperative position, the arm 16 is located in a cut-out of the upper section 12 in the shape and configuration corresponding to the shape and configuration of the arm 16 such that when the arm 16 is located in the inoperative position, the arm 16 does not protrude from the body of the upper section 12. As can be seen from the omitted section of the table-top 10 shown in FIG. 1, and by the broken lines shown in FIG. 2, a flange 18 extends downwardly from the underside face of the table-top 10.

Although not shown in detail in the Figures, the flange 18 and the arm 16 include locking mechanisms such as cooperating magnetised portions or inter-coupling male and female formations which when the arm 16 is pivoted in the direction of arrows B secures the arm in the operative position as shown in FIG. 2. With the arm 16 locked in the operative position, the table-top 10 is prevented from inadvertently folding into a collapsed orientation by a passenger or crew member bumping the table-top 10. The table-top 10 is able to be folded into the collapsed position by manually releasing the locking mechanism between the arm 16 and the flange 18 and returning the arm 16 into the inoperative position shown in FIG. 1.

The upper and lower sections 12 and 13 of the stand assembly 11 are interconnected at a junction identified by circle Z in FIG. 3 which is shown in an enlarged cross section in FIG. 4. Specifically, the junction is in the form of a swivel mechanism which allows the upper section 12 of the stand assembly 11 and thus the table-top 10 to pivot about the axis of the swivel mechanism identified by a dashed line X in FIG. 2 and in the direction of arrows A shown FIGS. 1 and 2. As can be seen in FIG. 4, the junction between the upper and lower sections comprises abutment surfaces of the upper and lower sections which, may for example, comprise silicone or Teflon catered surfaces. The swivel surfaces are coupled together by way of male and female formations. Specifically, the lower section of the stand assembly includes a cavity 19 having a large diameter and a shoulder 20 that defines a narrow opening 21 to the cavity 19. The male formation of the upper section includes a head 22 that is located in the cavity 19 of the lower section and a neck 23 that extends through the narrow opening 21 and allows free rotation of the upper and lower sections 12 and 13 of the stand assembly 11.

The lower section 13 of the stand assembly 13 is a body having a foot formation 24 in the form of an inverted U-shape that straddles an object such as railings 25, specifically mounted to the outside of an aircraft bed, the outside frame of the aircraft bed or a member extending on the outside of an aircraft chair. The inverted U-shape straddles the railing 25 and is releasably mounted to the railing 25 by way of a clamping device having an adjustable engagement surface 26. One side of the U-shaped provides a fixed engagement surface 27 and the other side of the U-shape comprises a threaded opening which receives a threaded rod 28 connected to the adjustable engagement surface 26. As can be seen in FIGS. 2 and 3, an adjustment knob 29 is connected to the threaded rod 28 to enable manual adjustment of the engagement surface 26 by rotating the adjustment knob 29.

In use, the adjustment knob 29 can be rotated to tighten and loosen contact between the fixed and adjustable engagement surfaces 26 and 27 on the railings 25 of a bed or seat as desired. It is also evident from the figures generally that the portable table is interchangeable in the sense that the table can be used with any orientation of aircraft seating. Hence, it is only necessary for one form of the table to be manufactured and carried on an aircraft and the use of the table is simplified. With regard to the latter point, cabin crew will not have to select the correct table from a range of tables.

As can be seen in FIGS. 1 and 5, an abutment surface 30 is located on the outside of the foot formation such that when the table-top 10 is folded from a collapsed position as shown in FIG. 5, the underneath side of the table-top 10 abuts against the abutment surface 30 thereby preventing the flange 18 on the underneath side of the table-top 10 from being over stressed when the table-top 10 is folded into a collapsed position. The abutment surface 30 may be magnetised or otherwise formed to cooperate with the table-top 10 to positively retain the table-top in the collapsed position.

Those skilled in the art of the present invention will appreciate that many modifications and variations may be made to the preferred embodiment without departing from the spirit and scope of the present invention.

1. A portable table suitable for an aircraft, the portable table including:
a) a table-top (10); and
b) a stand assembly (11), wherein the table-top (10) is moveably connected to the stand assembly (11) such that the table-top (10) can be changed from an erected orientation in which the table-top (10) is supported laterally to the stand assembly (11) and a collapsed orientation in which the table-top (10) is substantially parallel to the stand assembly, and wherein the stand assembly (11) includes a releasable connector (24) for releasably mounting the portable table to an object (25) that can act as a support for the table.

2. The portable table according to claim 1, wherein one end of the stand assembly (11) is pivotally connected to the table-top (10) to allow the table-top (10) to pivot between the erected orientation and the collapsed orientation.

3. The portable table according to claim 1 or claim 2, wherein a hinge mechanism (15) pivotally interconnects the table-top (10) and the stand assembly (11).

4. The portable table according to any one of the preceding claims includes a stop member that, when in an operative position, bears against and prevents the table-top (10) from moving into the collapsed orientation when the table-top (10) is erected, and when in an inoperative position, allows the table-top (10) to move into the collapsed orientation.

5. The portable table according to claim 4, wherein the stop member is in the form of a retractable arm (16) that can be moved between the operative position in which the arm (16) bears against an underside of the table-top (10) and the inoperative position in which the arm (16) can be moved into the collapsed orientation.

6. The portable table according to claim 5, wherein the retractable arm (16) is pivotally mounted to the stand assembly (11) and can be pivoted between the operative position and the inoperative position.

7. The portable table according to any one of claims 4 to 6, including a locking mechanism that can lock the stop member in the operative position and thereby prevent the table-top (10) from inadvertently collapsing while in use.

8. The portable table according to claim 7, wherein the locking mechanism includes co-operating magnetised portions attached on the table-top and the stop member.

9. The portable table according to claim 7, wherein the locking mechanism includes co-operating inter-fitting male and female formations on the table-top and the stop member.

10. The portable table according to claim 8 or claim 9, wherein a flange (18) extends downwardly from the underside of the table-top (10) and the stop member is coupled to the flange (18) by the locking mechanism to secure the stop member in the operative position and prevent the table-top from pivoting into the collapsed orientation.

11. The portable table according to any one of the preceding claims, including a swivel mechanism that can allow the table-top (10) to pivot or rotate about an axis substantially lateral to a plane of the table-top (10) when in the erected orientation.

12. The portable table according to claim 11, wherein the stand assembly (11) includes two sections, which when the portable table is viewed in the erected orientation are upper and lower sections (12 and 13), and the sections (12 and 13) are interconnected by the swivel mechanism.

13. The portable table according to claim 12, wherein the swivel mechanism comprises co-operating male and female formations that allow free rotation relative to each other.

14. The portable table according to claim 13, wherein the female formation is in the form a cavity (19) having a large diameter and a shoulder (20) that defines a narrow opening (21) to the cavity and a male formation that has a head (22) received by the cavity (19) and having a neck portion (23) extending through the opening 21.

15. The portable table according to any one of the preceding claims, wherein the releaseable connector (24) is a clamping device having a fixed engagement surface (27) and an adjustable engagement surface (26) that can each bear against the object (25) and can frictionally secure the stand assembly (11) to the object (25).

16. The portable table according to claim 15, wherein the level of contact by the fixed and adjustable engagement surfaces (27 and 26) on the object (25) is facilitated by the adjustable engagement surface (26) being operatively screw thread mounted (28).

17. The portable table according to claim 15 or claim 16, wherein the releasable connector (24) is in the form of an invert U-shape that can straddle the object (25) to which the portable table is mounted and the adjustable engagement surface (26) is screw threadably mounted to one of the legs of the U-shape and the fixed engagement (27) is provided by the other leg of the U-shape.

18. The portable table according to any one of the preceding claims, wherein the object (25) is part of an aircraft seat or bed.

19. A combination including:
a) an aircraft lounge in the form of either a seat or bed of an aircraft; and
b) a portable table including i) a table-top (10), and ii) a stand assembly (11), wherein the table-top (10) is moveably connected to the stand assembly (11) such that the table-top (10) can be changed from an erected orientation in which the table-top (10) is supported laterally of the stand assembly (11) and a collapsed orientation in which the table-top (10) is parallel to the stand assembly (11), and wherein the stand assembly (11) includes a releasable connector (24) for releasably mounting the portable table to the aircraft seat or bed.
